(19) United States
(12) Patent Application Publication
(10) Pub. No.: US 2009/0140444 A1
(43) Pub. Date: Jun. 4, 2009

(54) Compressed gas system useful for producing light weight drilling fluids

(75) Inventors: Randy J. Smith, Poteau, OK (US); Patrick F. Hobbs, Houston, TX (US); Charles F. Bellinger, College Station, TX (US); Kevin W. Smith, Houston, TX (US)

Correspondence Address: William L. Krayer, 1771 Helen Drive, Pittsburgh, PA, 15216, US

(73) Assignee: Total Separation Solutions, LLC

(21) Appl. No.: 12/287,343

(22) Filed: Oct. 8, 2008

Related U.S. Application Data
(60) Provisional application No. 61/004,661, filed on Nov. 29, 2007.
(60) Provisional application No. 61/062,932, filed on Jan. 30, 2008.

(51) Int. Cl. B01F 3/04; F04B 23/04

(52) U.S. Cl. 261/77; 417/199.1; 261/121.1

(57) ABSTRACT

A compressor station having at least one primary compressor and a booster compressor is controlled to conserve energy and air, and to respond quickly to sudden changes in demand for air, by employing a volume bottle to buffer changes in air pressure and by recycling already compressed air from the intake to the output of the booster compressor. The system may be used in air drilling and to provide compressed air for generating low density drilling fluid on site by injecting microbubbles into a base drilling fluid. Two different methods of generating microbubbles are illustrated. The primary and booster compressors are kept in a state of readiness during drill pipe connection time, providing for a rapid resumption of pressure and air flow after connection is completed. The system can utilize gases other than air.

### RELATED APPLICATIONS

This application claims the full benefit of Provisional Application 61/004,661 filed Nov. 29, 2007 and Provisional Application 61/062,932 filed Jan. 30, 2008, both of which are specifically incorporated herein in their entireties.

### TECHNICAL FIELD

Light weight drilling fluids are provided while drilling a well, by introducing bubbles to the fluid. Utilizing primary compressors and a booster compressor, the system responds to interruptions and resumptions of air supply during drill pipe connections and other abrupt or significant changes in system demand, by allocating air (or other gas) into the drilling fluid or into a compressed gas storage and/or recycling system. The system is versatile in that it may deliver 100% air (gas) to the drill pipe, and may be used in contexts other than well drilling.

### BACKGROUND OF THE INVENTION

In drilling wells for oil and gas, air drilling has been used successfully for many underbalanced and other drilling operations, but, as is the case with many other technical processes, air drilling could benefit from improvements. A particular problem with air drilling is the resumption of desired downhole pressure and flow when drilling is interrupted to make piping connections. As the drill continuously penetrates into the earth, additional sections of pipe must be secured to the existing piping, creating a transition interval (“connection time”), which necessitates highly reduced pressures and reduced downhole flow, if any. Almost always, the air compressors are kept operating in one mode or another in order to be able to respond immediately to a renewed call for air flow, wasting energy and sometimes causing overheating and damage to the compressors. Inadequate circulation of drilling fluid around the drill bit for too long of an interval can also result in a stuck drill bit, among other difficulties well known in the art. The industry has developed various techniques to ameliorate these problems, but they continue to plague the operators. A basic requirement of an air supply system for air drilling is the ability to deliver a steady and reliable flow of air at the desired pressure. But, even apart from the problem of connection time, the demand for air is not always steady. Another problem more or less endemic in air drilling is the occasional sudden shift in demand for air as the drill bit penetrates through strata presenting different pressures, even greatly reduced pressures such as may be presented by penetrating an unforeseen cavity in the earth formation. Sudden demands for significantly higher pressures mean sudden demands for significantly higher air volume, since air is compressible. An inability to deliver the appropriate amount and pressure of air in a short interval can result in unwanted intrusions of fluid and other matter into the wellbore, or unnecessary losses of fluid into the formation strata.

Contemporary air drilling rigs commonly utilize rotary centrifugal air compressors—usually two or more—coupled to a positive displacement, usually reciprocating piston, booster. This arrangement has a history of providing a reliable supply of air during steady state conditions, but tends to be inefficient in that it produces more compressed air than is actually used downhole, and it is difficult to control in periods of rapidly changing demand. In many situations of changing demand, the compressors and booster either tend to “fight” each other, or far too much air is simply vented, resulting in significant wastage of energy. In some cases, either the booster or a compressor will become overloaded and break down due to overheating, causing much expense and delay to the operator.

Foams have been used frequently where light weight drilling fluids are desired. Generally, foams have a very high percentage of air or other gas and a density less than three pounds per gallon of fluid. Frequently the operators will monitor drilling fluid density and/or hydrostatic head, and try to control them for various reasons. For some applications, such as many underbalanced drilling operations, it would be desirable to use drilling fluids in the range of 5 to 8 pounds per gallon, but the art has been slow to develop such fluids. For many drilling operations, an ideal system would provide drilling fluids of various weights in rapid response to the conditions encountered or the changing specifications of the operators for whatever reason.

### SUMMARY OF THE INVENTION

Our system provides practical solutions to the above described problems and desiderata. We are able to deliver a steady supply of air or other gas to the well head for introduction to the well during drilling while also being able economically and efficiently to respond to sudden changes in demand for volume, pressure, and density. Our invention is able to significantly reduce the energy requirements of the compressors and boosters and at the same time respond quickly to abrupt changes in demand for air or other gas. Our compressed gas supply system can be used in any application requiring rapid, economical, responses to abrupt changes in demand.

Our invention is a method of regulating the delivery of compressed gas from a source of compressed gas to an end use line, the source comprising at least one primary compressor and a booster compressor for providing gas at a pressure above a predetermined value A, the booster compressor having a gas inlet and a gas outlet, the method comprising: (a) passing compressed gas into a volume bottle from the at least one primary compressor and regulating the quantity of gas within the volume bottle within desired limits; (b) while the use requirements for gas in the end use line include a pressure below the predetermined value A, passing gas from the volume bottle to the end use line; (c) while the use requirements for gas in the end use line include a pressure above the predetermined value A, (i) passing gas from the volume bottle to the inlet of the booster compressor and (ii) passing gas from the outlet of the booster compressor to the end use line; (d) when the use requirements for gas in the end use line include a pressure reduced suddenly from the pressure above the predetermined value A, recycling gas from the outlet to the inlet of the booster compressor, (e) when the use requirements for gas in the end use line include an end use pressure greater than the suddenly reduced pressure of step (d), ceasing the recycling of gas from the outlet to the inlet of the booster compressor, and (f) performing either step (b) or step (c).

Our invention is also a method of controlling and conserving compressed gas for use as a drilling fluid or component thereof, the compressed gas provided by at least one primary compressor and a substantially continuously operating booster compressor having gas intake means and gas output means comprising (a) providing a flow of gas from the output means of the booster compressor at an enhanced pressure of at least 400 psi to a drilling fluid line for use as a drilling fluid or component thereof, (b) when the pressure specification for drilling fluid in the drilling fluid line declines to a value substantially below the enhanced pressure, substantially reducing or terminating the flow of gas to the drilling fluid line and opening the flow of gas from the booster compressor to (i) a volume bottle and (ii) the intake means of the booster compressor, and (c) directing gas from the output side of the booster compressor to the intake side of the booster compressor, thereby conserving compressed gas by enabling the booster compressor to operate at a substantially reduced work level.

Also, our invention includes a method of making a light weight drilling fluid comprising compressing a gas with at least one primary compressor, further compressing the gas with a booster compressor, passing the gas at least partly from the booster compressor into a microbubble machine, passing a base drilling fluid into the microbubble machine, thereby making a dispersion of microbubbles in the base drilling fluid, and withdrawing a light weight drilling fluid from the microbubble machine.

In addition, our invention includes readily transportable apparatus for conserving compressed gas at a well drilling site, the well drilling site having at least one primary gas compressor and a booster compressor, and a line for conveying drilling fluid to a wellbore, the readily transportable apparatus comprising at least one gas line including means for connecting the compressors to the drilling fluid line, and a volume bottle in the line for buffering pressure changes in the gas line.

As indicated above, certain components used in our system are commonly found in the oil field. Certainly where air drilling is practiced, air or other gas compressors will be present, and accordingly our invention is adapted to utilize compressors and drilling rigs already on site. Accordingly, in one aspect, our invention, can be mounted on a skid or truck for transportation to a drilling site, where it can be connected to the compressors and drilling pipe. However, the advantages and uses of our invention are not limited to oil field applications—such a mobile system can be used in many other situations where compressed air is required; also the compressors can be equipped by the manufacturers or suppliers with the controls and valves necessary to carry out the invention.

Our invention may use gases other than air. Wherever we mention air, we could use, and we intend to include, nitrogen (see Chitty U.S. Pat. No. 6,494,262 for example), exhaust gas (Moody U.S. Pat. No. 5,663,121) or air from which a substantial part of the oxygen has been removed, resulting in a gas comprising more than 85% nitrogen, or any other practically available gas. Air, however, remains the most inexpensive and available gas. See King et al U.S. Pat. No. 5,249,635. Air is by far the most common gas utilized by a compressed air system comprising at least one primary compressor and a booster compressor. As used herein, a primary compressor is a compressor whose intake is from a low-pressure source, as the atmosphere, and a booster compressor is one whose intake is from an already somewhat pressurized source; this pressure will be increased by the booster compressor. Commonly, the primary compressor(s) are dynamic compressor(s) and the booster compressor is a reciprocating positive displacement compressor; however, we do not intend to be limited to these types of compressors. We do not intend to rule out the use of one or more compressors intermediate the primary and booster compressors, perhaps connected in series, but normally when two or three primary compressors are used, the second and third ones are employed as illustrated herein in order to assure the availability of larger volumes of air.

Our drilling fluid may be 100% air, but we also contemplate a drilling mud containing gas injected by our system. The gas may be introduced to the liquid drilling mud base in the form of substantially evenly dispersed microbubbles of one of the above named gases, thus creating a highly textured drilling fluid having substantially reliable properties.

As used herein, the term “microbubble” means a bubble having a diameter when first formed, regardless of the pressure at formation, from 100 nanometers to 100 micrometers, preferably from 20-40 microns in diameter. Depending on the drilling mud composition, at some concentration of gas, and certainly if more than 70% of the volume of the drilling fluid comprises air, the microbubbles may merge with each other and/or tend to form contiguous air pockets, forming the physical structure of a foam. Where the drilling fluid contains microbubbles, the bubbles will be compressed in high pressure zones, reducing their diameters, and some of the air or other gas may become dissolved in the fluid, which may alter the density of the fluid.

As used herein, the term “textured” means that the composition of the drilling fluid is substantially uniform, and particularly that the microbubbles remain in discrete, dispersed form although they may be more or less compressed depending on the pressure on the fluid. When we speak of the formation of microbubbles, we mean that the bubbles are of a size described above and are substantially evenly dispersed.

### BRIEF DESCRIPTION OF THE DRAWINGS

FIG. 1 is a block diagram of our apparatus for delivering a gas, in this case air, to a point of use, such as a well during the drilling operation.

FIG. 2 is a block flow sheet showing the delivery of light weight drilling fluid to a well, using microbubble machines; a bypass is included for 100% air.

In FIG. 3, the systems of FIGS. 1 and 2 are combined; in addition, a booster storage tank is shown.

FIGS. 4a, 4b, and 4c describe a cavitation device which can be used as a microbubble machine.

FIG. 5 illustrates the operation of a membrane microbubble machine for making a low density drilling fluid.

### DETAILED DESCRIPTION OF THE INVENTION

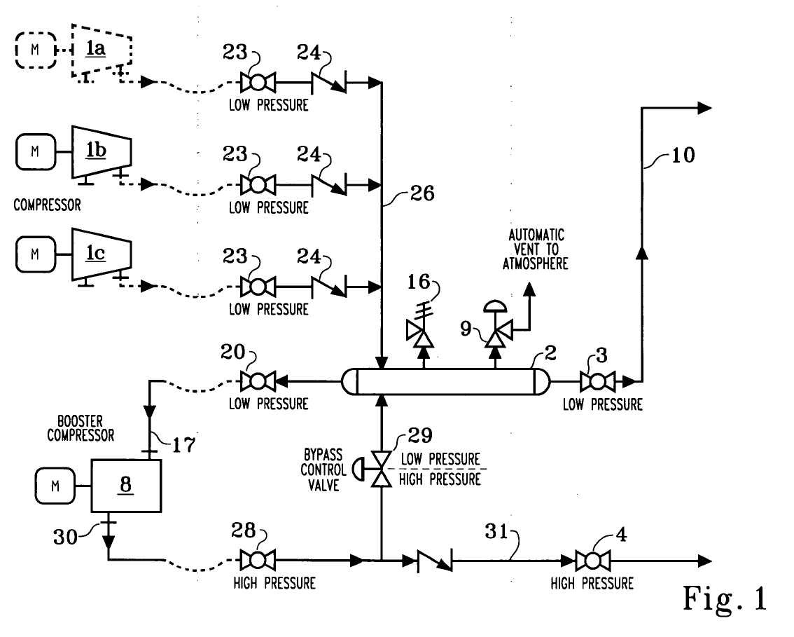

Referring now to FIG. 1, one or more—in this case, three—primary air compressors 1a, 1b, and 1c are connected in common through a manifold 26 to a volume bottle 2 capable of holding compressed air. Compressors 1a, 1b, and 1c are centrifugal compressors, but any compressor capable of performing the functions described herein is satisfactory in our invention. The compressed air passes through ball valves 23 and check valves 24 to the manifold 26 before entering volume bottle 2; depending on demand, the operator can use one, two or three compressors as needed. Volume bottle 2 acts to buffer changes in pressure, depending on downstream demands or conditions. Low pressure air from volume bottle 2 can flow through ball valve 3 and the low pressure end use line 10, or through ball valve 20 to the high pressure booster 8.

At least one of the compressors 1a, 1b, and 1c operates continuously, and is assisted by a booster compressor 8, here illustrated as a positive displacement compressor, in particular a reciprocating compressor. Air from the volume bottle 2 feeds through ball valve 20 to the low pressure inlet 17 on booster 8. The air is compressed in booster 8 and sent as high pressure air through outlet 30 and ball valve 28 to high pressure line 31. Depending on downstream (end use) air demand, control valve 29 may direct air from line 31 to volume bottle 2 Any positive displacement compressor, desirably a reciprocating compressor, may act as the booster (reciprocating compressor) 8 in our invention; double-acting and other configurations of reciprocating compressors may be used. The term “reciprocating compressor” as used herein is meant to include any functionally equivalent positive displacement compressor. The reciprocating compressor is used in our invention as a booster to increase the volume, pressure or flow of air available to the end use served by either high pressure end use line 31 or low pressure end use line 10. Persons skilled in the art will recognize that control valve 29 marks a boundary, indicated by a dotted line, between high and low pressure requirements for the equipment. We do not intend to be limited to reciprocating compressors and the type of booster illustrated in our invention; we may us any booster compressor as defined above.

As booster 8 is able to deliver substantially higher volume, pressure or flow than one or more compressor(s) 1a, 1b, and/or 1c acting without a booster, the valves, meters and the like, as well as the lines, such as line 31, themselves handling compressed air originating with reciprocating booster 8, are desirably engineered to handle high flows and pressures—for example from 500 to 5000 psi—while the low pressure portions such as manifold 26, line 10, and their associated valves, meters and related equipment, will normally handle pressures of 500 psi or below. Persons skilled in the art will realize that these values are merely examples, and other, different values (such as a predetermined value A, or alternatively 400 psi) or ranges may be designed into the system depending on the desires and objectives of the operators and the specifications of the compressors and other equipment, the point being that the booster is able substantially to increase the delivery of compressed air to the end use, while some applications or periods of operation may not require such high pressures and large volumes.

Automatic controls not shown are designed to utilize the recycling abilities (control valve 29 to low pressure inlet 17, for example) built into the system of FIG. 1. The system is able to respond immediately to a decrease or shut-off in demand for air in end use line 10 or 31 by permitting both the primary compressor(s) 1a, 1b, and/or 1c and the booster 8 to continue operating, although one or more of them may reduce its output by internal controls. For the booster compressor 8 a decrease in demand in line 31 will activate controls to cause valve 4 to cut off flow to the end use and actuate control valve 29 to by-pass high pressure flow from line 31 back into volume bottle 2, thus causing a recycling of air in reciprocating compressor 8. At the same time or soon thereafter, compressor 8 may further reduce its flow output, by internal capacity controls, after detecting an increase in pressure in volume bottle 2. Thus booster 8 is effectively placed in a “ready” mode, and the work demand on compressors 1a, 1b, and/or 1c will be reduced by their internal controls detecting an increase in pressure in volume bottle 2. If more than one of the primary compressors has been working, one or two may be completely idled, and the third kept at a low level of work. The “ready” mode of the booster 8 means that the booster 8 is working, but is not wasting either energy or compressed air, since it is recycling air which is already compressed, and not utilizing automatic vent valve 9 as was the common practice in the prior art, although its presence is still recommended and it may find minimal use. Volume bottle 2 may also have a relief valve 16 as a safety measure.

When full demand for air is resumed, the system is able to react immediately. Sensors, transducers, and flow meters in communication with controllers will open appropriate valves and activate the compressor capacity controls to permit the flow of air to the end use. Either high or low pressure can be supplied over a wide range of volumes and flow rates.

The system can move into a “ready” mode during an interruption of demand. The system recognizes that the booster 8 will be kept running at a low-demand pace determined normally by its internal controls or settings by the operator, but will automatically economize on fuel and compressed air by setting up a loop whereby compressed air passes from outlet 30 through valve 28 and line 31 to control valve 29, sending air to volume bottle 2; from volume bottle 2 air is returned to reciprocating compressor 8 through valve 20 and inlet 17. Relief valve 12 and automatic vent 14 provide safety against overload of volume bottle 2. Pressure, flow and volume controls not shown will draw on both the volume bottle 2 and the booster 8 as well as manifold 26 to resume quickly the supply of air in either of the end use lines 10 or 31. The system of FIG. 1 is not limited to use in well drilling, but is useful for any application where a wide range of pressures and volumes is anticipated, and is particularly useful where frequent interruptions in demand are contemplated.

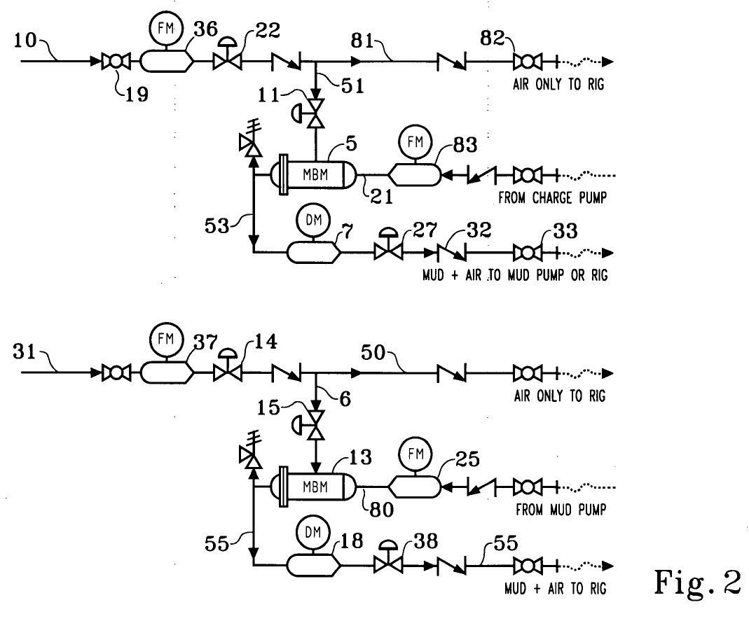

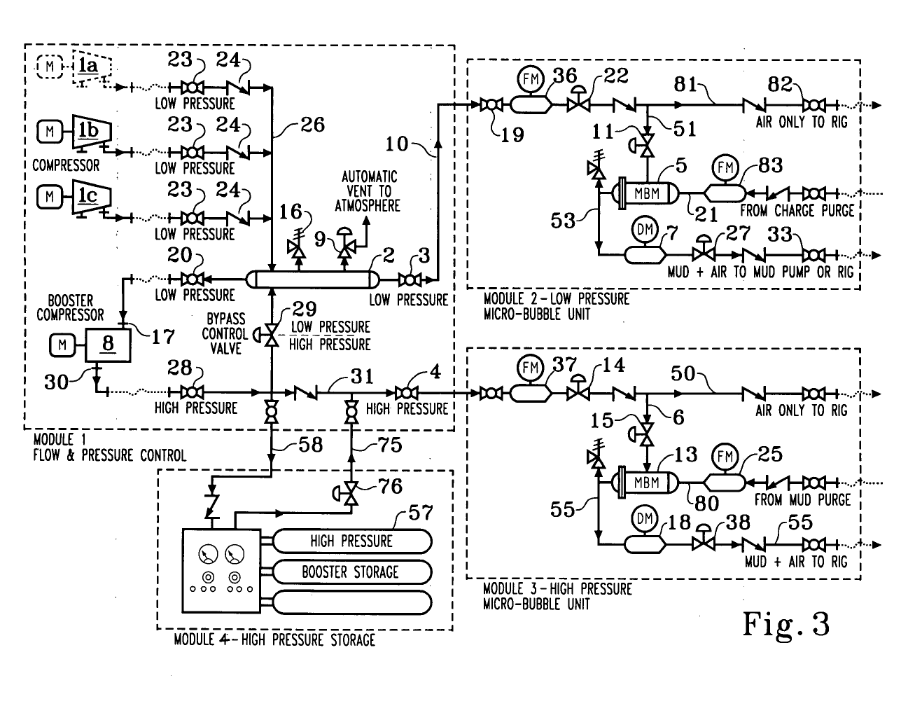

FIG. 2 illustrates a practical use of the system of FIG. 1, as a source of pressurized air for a well drilling rig. Separate systems are shown for a low pressure source (see end use line 10 of FIG. 1) and a high pressure source (see end use line 31 from FIG. 1). They may be assembled in the form of modules that can be readily transported on a skid, flat bed truck or other mode of transportation to the well site. The separate systems can be combined on a single skid in combination with the volume bottle 2 and its associated equipment (see FIG. 1) and the booster storage vessel 57 and associated equipment as shown in FIG. 3.

Low pressure air passes from line 10 (see low pressure end use line 10 in FIG. 1) through valve 19 and flow meter 36 to control valve 22. Flow meter 36 monitors the air flow in line 10 as it passes either to low pressure microbubble machine 5 through control valve 11 on line 51 or directly to the drilling rig through valve 82 on line 81.

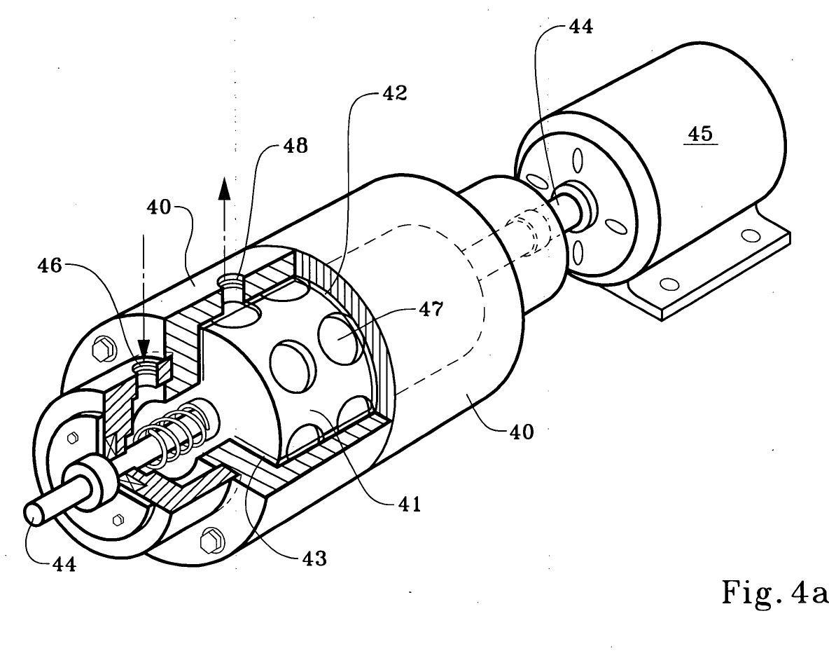

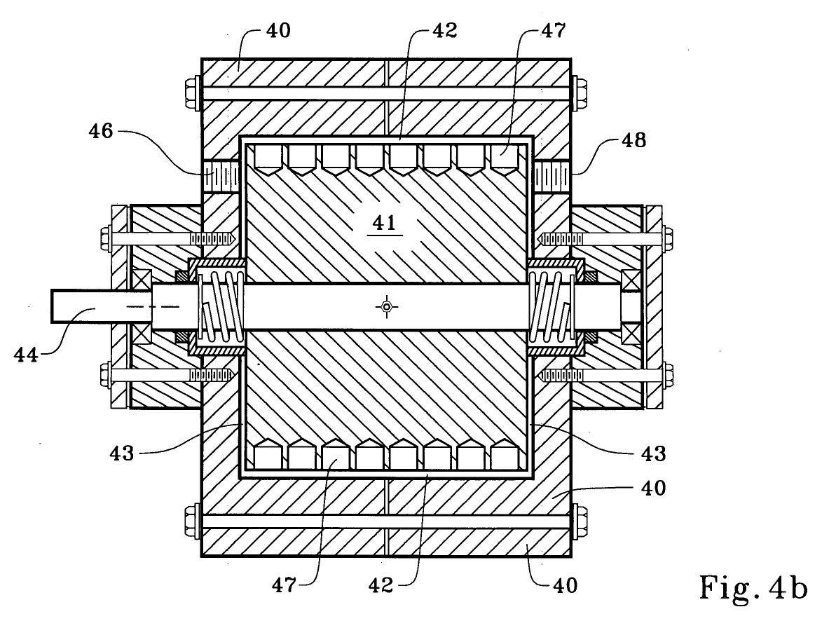

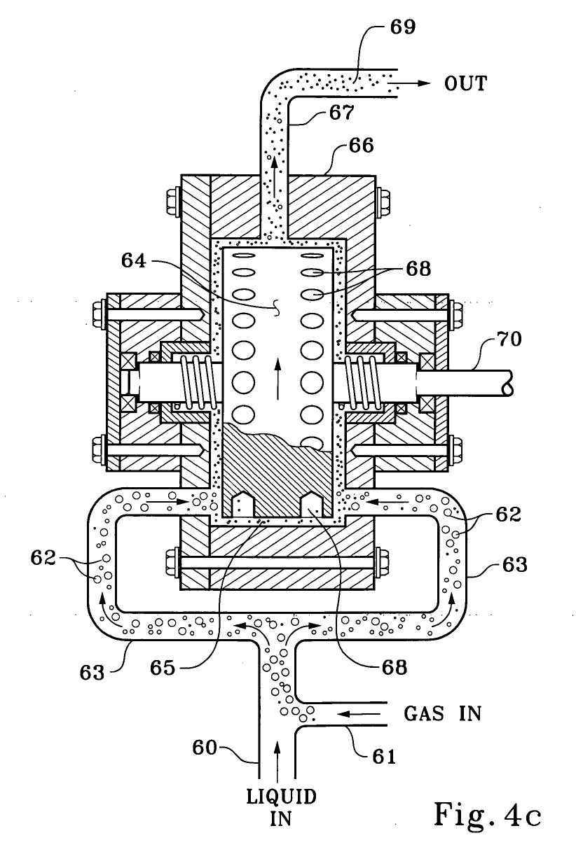

A base drilling mud for use in well drilling is prepared or stored in a vessel not shown and sent by a charge pump not shown through flow meter 83, where a signal representing flow rate is generated and forwarded to the control system not shown. From flow meter 83 the base drilling mud is sent to low pressure microbubble machine 5, detailed in FIGS. 4a, 4b and 4c.

Low pressure microbubble machine 5 receives drilling mud from line 21 and air from line 51, forming discrete and dispersed microbubbles of air in the drilling mud as explained with reference to FIGS. 4a, 4b, and 4c, thus reducing the density of the liquid drilling fluid. The reduced-density drilling fluid proceeds through line 53 to density meter 7, which displays or transmits a signal representative of density to the control system, continues through control valve 27 and further through check valve 32 and ball valve 33 to the drilling rig. Optionally, the light weight mud in line 53 may be passed to a higher pressure mud pump (not shown) after ball valve 33 before going to the drilling rig.

High pressure air may alternatively be delivered from a source in line 31 (see high pressure end use line 31 in FIG. 1) through flow meter 37 and control valve 14 to microbubble machine 13 by way of control valve 15 on line 6. If the drilling operation requires high pressure air only, the air may proceed in line 50 directly to the rig.

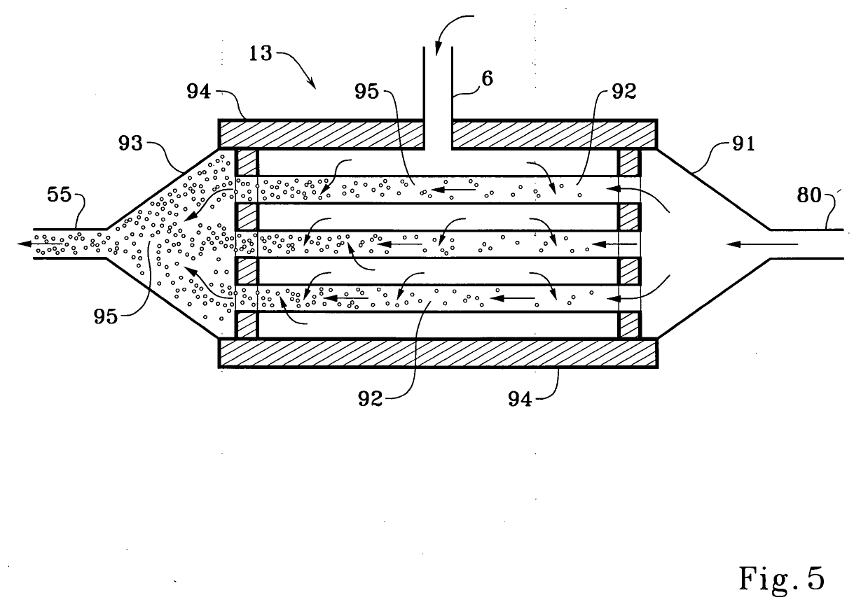

High pressure microbubble machine 13 comprises a housing forming a chamber holding a membrane tube as illustrated in FIG. 5. In addition to high pressure air from line 31, microbubble machine 13 receives base drilling fluid from line 80, which in turn receives it from a high pressure mud pump, not shown, after passing through flow meter 25. Since the drilling mud entering microbubble machine 13 may be at a very high pressure, for example 2000 psi or more, it is necessary for the air passing through the wall of the membrane tube (see FIG. 5) to enter the microbubble machine at an even higher pressure. The drilling mud now containing microbubbles is sent from the interior of the membrane tube to line 55 to density meter 18 and control valve 38. Density meter 18 feeds a signal representing density of the drilling fluid to the control center, which more or less continuously controls the ratio of air (gas) in the fluid to achieve the desired density. High pressure drilling fluid moves through line 55 to the drilling rig, where it is circulated to the drill bit and returned in a more or less conventional manner.

Gas or air at either high or low pressure from the system of FIG. 1 can also be mixed with base drilling fluid by conventional means not shown to prepare a foam or liquid/gas mixture other than the textured drilling fluid obtainable by using a microbubble machine, if such a fluid is desired. Pressure and flow of the gas can be controlled for such alternate drilling practices.

Thus, four options are shown in FIG. 2 for the use of compressed air in well drilling—the air-only options, at low or high pressure, of lines 81 and 50, and two options for liquid mud of reduced density, namely the high pressure option of line 55 and the lower pressure option of line 53. It should be understood that any suitable microbubble machine may be used in either the high or low pressure options; we do not intend to be restricted to the particular machines or devices for introducing microbubbles, nor do we intend to be restricted to the particular sequences of microbubble machines with a high pressure pump; for example, under some circumstances a high pressure pump may operate successfully downstream of the microbubble machine 13 instead of or in addition to upstream, and in some circumstances it may be possible for high pressures to be introduced into the low density mud of line 53 downstream of the microbubble machine 5. The control system can be set to switch from high pressure to lower pressure, and from high volume to lower volume of air; densities, pressures, flow rates and volumes can all be regulated to suit the purposes of the operators.

The equipment should be engineered to handle the high pressures and flow rates frequently demanded in drilling practice. While a triplex pump is suitable and commonly used for high pressures and volumes, any pump able to provide the drilling fluid necessary for drilling may suffice. Persons skilled in the art may realize also that under some of the higher pressures common in the art, the microbubbles will be compressed or even dissolved in the liquid, and the density measurements should be adjusted accordingly. Normally, however, it is desirable for the microbubbles to be substantially evenly dispersed and have a substantially uniform size, preferably from 20 to 40 microns in diameter or generally from 100 nanometers to 100 micrometers in diameter, giving the modified fluid an even texture.

Proceeding now to FIG. 3, it will be seen that the system of FIG. 1 is depicted within the dotted line area labeled Module 1, the low pressure portion of FIG. 2 is labeled Module 2, the high pressure portion of FIG. 2 is labeled Module 3, and a fourth section is labeled Module 4. Low pressure end use line 10 is connected to Module 2 and high pressure end use line 31 is connected to Module 3. Optional booster storage vessel 57 can receive high pressure air from booster 8 through line 58 and control valve 76 can release stored air through line 75 to high pressure end use line 31. Under the operator-discretionary controls and valve positions, booster storage vessel 57 accepts and stores high pressure compressed air for assisting with an immediate response when a resumption in demand, including an abrupt and sharply elevated demand, for air occurs.

Except for primary compressors 1a, 1b, and 1c, booster 8, and the liquid drilling mud sources not shown, which are normally already on the drilling site, the equipment of FIG. 3 is conveniently assembled in a readily transportable skid form. That is, the entire modules 2, 3, and 4, together with volume bottle 2 and its associated valves, can be portable. Simple connections can be made at the compressors and to the drilling rig. Appropriate electrical connections will also be required for meters, motors, valves and the like, but a power source is also expected to be at the site. An important aspect of our invention is that this versatile drilling fluid system can be inserted conveniently in a wide variety of air or other gas drilling operations.

Operation of the system is as follows. A drilling rig is conducting a drilling operation in a well containing drill pipe downstream of Modules 3 and 4. The operators utilize a base drilling fluid which is mixed in or stored in a vessel or vessels not shown. On demand from the control system, the base drilling fluid is delivered, through one or both of flow meters 25 and 83, to microbubble machines 5 and/or 13, which are able to disperse finely divided microbubbles into the fluid in an amount and at a rate, proportioned to the flow rate of the base drilling fluid, to modify the density of the base drilling fluid and create a textured reduced-density drilling fluid for use in the well. Pressurized air for making the microbubbles is supplied from Module 1 in the manner described with respect to FIG. 1 through either end use line 10 or 31. Pressure and flow of the drilling fluid to the drilling rig is controlled by control valves 38 and 27, primarily in response to the demand required by the operators. Or, if the drilling is in the “air only” mode, air is supplied through line 81 or 50.

As is known in the art of well drilling with air or liquid drilling fluid, a more or less steady flow of drilling fluid (or pressurized gas in the “air only” mode) is normally needed while the string of drill pipe moves downwardly, until another section of pipe is required. At this point, the flow of drilling fluid is temporarily halted or substantially reduced, either by control valves 27 and/or 38 or otherwise, and full pressure and flow will not be resumed until the connection of a new pipe segment is complete, lengthening the drill pipe string. In the past, such interruptions or disruptions in the substantially steady state of the system have caused difficulties for the operators because the dynamic compressors 1a, 1b, and 1c and related equipment such as booster 8 cannot practically be shut down. Much fuel and energy has been wasted by simply venting excess compressed gas (air) during the “down” connection time. In addition to interruptions in flow known as connection time, a more or less steady state demand can be disrupted by sudden changes in the formation pressure. Our system is able to provide the required air almost immediately on resumption of demand.

Referring further to FIG. 3, when the flow of or demand for drilling fluid is interrupted or disrupted, the air supply system is placed in the “ready” mode as explained with reference to FIG. 1. In addition, as illustrated in FIG. 3, the system may be supplemented by an optional booster storage vessel 57. During an interval of little or no demand for air, which frequently will be during drill pipe connection time, booster storage vessel 57 may receive air through lines 58 and 30 from booster 8. Booster storage vessel 57 is thus ready to supplement air delivery from the compressors 1a, 1b, and/or 1c and 8 on release by control valve 76.

FIGS. 4a and 4b are adapted from FIGS. 1a and 1b of Provisional application 61/004,661, which describes a method of placing microbubbles in a drilling fluid by feeding both a base drilling fluid and a gas into a cavitation device. FIGS. 1a and 1b of Provisional application 61/004,661 are in turn adapted from FIGS. 1 and 2 of Griggs U.S. Pat. No. 5,188,090. Preferably the cavitation device is one manufactured and sold by Hydro Dynamics, Inc., of Rome, Ga., most preferably the device described in U.S. Pat. Nos. 5,385,298, 5,957,122 6,627,784 and 5,188,090, all of which are incorporated herein by reference in their entireties. In recent years, Hydro Dynamics, Inc. has adopted the trademark “Shockwave Power Reactor” for its cavitation devices, and we sometimes use the term SPR herein to describe the products of this company and other cavitation devices that can be used in our invention.

Definition: We use the term “cavitation device,” or “SPR,” to mean and include any device which will cause bubbles or pockets of partial vacuum to form within the liquid it processes. The bubbles or pockets of partial vacuum have also been described as areas within the liquid which have reached the vapor pressure of the liquid. The bubbles or pockets of partial vacuum are typically created by flowing the liquid through narrow passages which present side depressions, cavities, pockets, apertures, or dead-end holes to the flowing liquid; hence the term “cavitation effect” is frequently applied. Cavitation devices can be used to heat fluids, but in our invention we use them to make microbubbles which are intended not to implode, but to remain in bubble form for incorporation into the base drilling fluid. To do this, a gas such as air is injected along with the base drilling fluid (liquid), and the conditions are controlled to generate microbubbles, preferably at a rate in response to the system's demand for density and flow. Cavitation devices of the type suggested herein can cause the bubbles to be dispersed and divided into quite small bubbles of substantially constant size.

The term “cavitation device” includes not only all the devices described in the above itemized U.S. Pat. Nos. 5,385,298, 5,957,122, 6,627,784 and 5,188,090 but also any of the devices described by Sajewski in U.S. Pat. Nos. 5,183,513, 5,184,576, and 5,239,948, Wyszomirski in U.S. Pat. No. 3,198,191, Selivanov in U.S. Pat. No. 6,016,798, Thoma in U.S. Pat. Nos. 7,089,886, 6,976,486, 6,959,669, 6,910,448, and 6,823,820, Crosta et al in U.S. Pat. No. 6,595,759, Giebeler et al in U.S. Pat. Nos. 5,931,153 and 6,164,274, Huffman in U.S. Pat. No. 5,419,306, Archibald et al in U.S. Pat. No. 6,596,178 and other similar devices which employ a shearing effect between two close surfaces, at least one of which is moving, such as a rotor, at least one of which has cavities of various designs in its surface as explained above, and which is capable of mixing a base drilling fluid and a gas to form substantially evenly dispersed and sized microbubbles.

FIGS. 4a and 4b show two slightly different variations, and views, of a cavitation device suitable for the generation of microbubbles in our invention.

A housing 40 in FIGS. 4a and 4b encloses cylindrical rotor 41 leaving only a small clearance 42 around its curved surface and clearance 43 at the ends. The rotor 41 is mounted on a shaft 44 turned by motor 45. Cavities 47 are drilled or otherwise cut into the surface of rotor 41. As explained in the above-identified Hydro Dynamics patents, other irregularities, such as shallow lips around the cavities 47, may be placed on the surface of the rotor 41. Some of the cavities 47 may be drilled at an angle other than orthogonal to the surface of rotor 41—for example, at a 15 degree angle. In a typical use of the device for heating liquid, the liquid is introduced through port 46 under pressure and enters clearances 43 and 42. In our invention, air (gas) is introduced also at port 46 at the same time the base drilling fluid is introduced, or somewhat upstream of port 46. An advantage of the cavitation device is that it can handle a drilling mud (in our case a base drilling fluid) containing substantial amounts of solids. As the fluid and air pass from port 46 to clearance 43 to clearance 42 and out exit 48 while the rotor 31 is turning, areas of partial vacuum are generated and heat is generated within the fluid from its own turbulence, expansion and compression (shock waves). The depth, diameter and orientation of the cavities may be adjusted in dimension to optimize efficiency and effectiveness of the cavitation device for mixing the base drilling fluid and the gas (air), and to optimize operation, efficiency, and effectiveness, with respect to particular fluid temperatures, pressures and flow rates, as they relate to rotational speed of the rotor 41. Smaller or larger clearances may be provided. Also the interior surface of the housing 40 may be smooth with no irregularities or may be serrated, feature holes or bores or other irregularities as desired to increase efficiency and effectiveness of bubble division and dispersion. Rotational velocity may vary considerably but may be on the order of 5000 rpm. The diameter of the exit 48 may be varied also. Note that the position of exit 48 is somewhat different in FIGS. 4a and 4b; likewise the position of entrance port 46 differs in the two versions and may also be varied to achieve different effects in the flow pattern within the SPR.

Another variation which can lend versatility to the SPR is to design the opposing surfaces of housing 40 and rotor 41 to be somewhat conical, and to provide a means for adjusting the position of the rotor within the housing so as to increase or decrease the width of the clearance 42. This can allow for different sizes of solids present in the fluid, to reduce the shearing effect if desired (by increasing the width of clearance 42), to vary the velocity of the rotor as a function of the fluid's viscosity, or for any other reason.

Operation of the SPR (cavitation device) is as follows. A shearing stress is created in the solution as it passes into the narrow clearance 42 between the rotor 41 and the housing 30. The solution quickly encounters the cavities 47 in the rotor 41, and tends to fill the cavities, but the centrifugal force of the rotation tends to throw the liquid back out of the cavity. Small bubbles, some of them microscopic, are formed. Where no gas is present, the small bubbles are imploded. The relatively large amount of gas present in the liquid in our invention, however, preserves the bubbles as microbubbles. The shearing, centrifugal force, and extreme turbulence effect excellent mixing. The texture of the drilling fluid can be observed in the substantial uniformity of bubble size and dispersion achieved by the cavitation device.

FIG. 4c is adapted from FIG. 1 of Hudson U.S. Pat. No. 6,627,784, one of the patents incorporated in its entirety by reference. FIG. 4c is a cavitation device differing slightly from the cavitation device of FIGS. 4a and 4b, which may also be employed as the microbubble machine 5 of FIG. 2. In FIG. 4c, drilling mud in conduit 60 is mixed with gas, usually air, from conduit 61, which may originate in line 10 of FIGS. 1 and 2. The gas immediately becomes dispersed in the form of bubbles 62 in conduit 63, which is split in two parts to enter the cavitation device at opposite sides of the rotor 64, which is mounted on shaft 70. As illustrated for the similar cavitation device in FIGS. 4a and 4b, the fluid enters clearance 65 and becomes subjected to the cavitation action imparted by passage of the bubble-containing drilling mud between rotating rotor 64, containing cavities 68, and housing 66, causing the formation of evenly dispersed microbubbles in the drilling mud 69 before it exits through conduit 67, which corresponds to line 53 of FIG. 2.

FIG. 5 is a more or less diagrammatic illustration of a membrane microbubble machine, in particular microbubble machine 13, shown above in the context of our system in FIGS. 2 and 3. A liquid base drilling mud is introduced through line 80 to header 91 and distributed to the interiors of membrane tubes 92, which are fixed in sealed relation to header 91 and a collector 93. Membrane tubes 92, as known in the art, are hollow tubes comprised of a porous cylindrical support covered by a membrane of specified porosity. The cylindrical supports are made of many different materials such as polymers, reinforced plastics, and porous ceramics, and the membranes also can vary considerably in composition, being also typically made of various porous polymeric, metal or ceramic materials. In some cases, the support and the membrane may comprise the same material. The membrane tubes are contained in a housing 94. Compressed air inters housing 94 through line 6 and fills the spaces between the membrane tubes 92. As discussed previously, the compressed air in line 6 is under high pressure, generally above 500 psi, and frequently much higher, i.e. 2000 psi or as high as 5000 psi. The housing 94, header 91, and collector 93, together with incoming line 6 for air, line 80 for drilling fluid, and line 55, for removing the fluid from the housing, must accordingly all be engineered to withstand the expected pressures. Air or other gas in line 6 and in the spaces between the membrane tubes 92 is maintained at a pressure higher than the pressure of the base drilling fluid within the membrane tubes 92, which causes the air to pass through the membranes and supports of the membrane tubes 92 and enter the liquid drilling fluid in the form of microbubbles 95. Base drilling fluid containing microbubbles 95 is collected in collector 93 and passed to line 55 as a light weight drilling fluid.

It will be appreciated that the microbubble machine 13 can be constructed in various ways. For example, each membrane tube could be in a separate housing; a much larger number of membrane tubes than shown could be contained in a housing, more than one entrance for air or drilling fluid could be constructed, and the header and collector could be designed differently. We do not intend to be restricted to the particular design shown. Tubes can be constructed with the membrane on the internal surface, and the gas can be passed through the tubes to be injected into the liquid on the exterior of the tubes; indeed, for this mode, a tubular shape may not be of interest; dead-end bulbs having interior membrane surfaces, for example, would be operable.

Operation of the microbubble machine 13, as indicated above, requires that the air pressure between the membrane tubes 92 be higher than the fluid pressure within their interiors. Pressure within the membrane tubes will be affected by the original pressure in line 80, but also by flow rates within the membrane tubes, which in turn may be affected by the decreasing density or increasing volume of the fluid as it passes through the tubes, picking up microbubbles. Another factor will be the size of the membrane pores; smaller pores require greater gas pressure to assure the gas passes through the membrane tube walls, although this effect may be ameliorated by a larger number of pores. Generally, the transmembrane pressure difference should be at least 50 psi; for most uses, a transmembrane pressure difference of 75-200 psi may be used. The manufacturer may recommend a transmembrane pressure difference range.

1. Method of regulating the delivery of compressed gas from a source of compressed gas to an end use line, said source comprising at least one primary compressor and a booster compressor for providing gas at a pressure above a predetermined value A, said booster compressor having a gas inlet and a gas outlet, said method comprising:
a. passing compressed gas into a volume bottle from said at least one primary compressor and regulating the quantity of gas within said volume bottle within desired limits;
b. while the use requirements for gas in said end use line include a pressure below said predetermined value A, passing gas from said volume bottle to said end use line;
c. while the use requirements for gas in said end use line include a pressure above said predetermined value A, (i) passing gas from said volume bottle to said inlet of said booster compressor and (ii) passing gas from said outlet of said booster compressor to said end use line;
d. when the use requirements for gas in said end use line include a pressure reduced suddenly from said pressure above said predetermined value A, recycling gas from said outlet to said inlet of said booster compressor,
e. when the use requirements for gas in said end use line include an end use pressure greater than said suddenly reduced pressure of step (d), ceasing the recycling of gas from said outlet to said inlet of said booster compressor, and
f. performing either step (b) or step (c).

2. Method of claim 1 including, in step (d), recycling gas from said outlet to said volume bottle and from said volume bottle to said inlet of said booster compressor.

3. Method of claim 1 wherein said gas is air.

4. Method of controlling and conserving compressed gas for use as a drilling fluid or component thereof, said compressed gas provided by at least one primary compressor and a substantially continuously operating booster compressor having gas intake means and gas output means comprising
(a) providing a flow of gas from said output means of said booster compressor at an enhanced pressure of at least 400 psi to a drilling fluid line for use as a drilling fluid or component thereof,
(b) when the pressure specification for drilling fluid in said drilling fluid line declines to a value substantially below said enhanced pressure, substantially reducing or terminating said flow of gas to said drilling fluid line and opening the flow of gas from said booster compressor to (i) a volume bottle and (ii) said intake means of said booster compressor, and
(c) directing gas from said output side of said booster compressor to said intake side of said booster compressor, thereby conserving compressed gas by enabling said booster compressor to operate at a substantially reduced work level.

5. Method of claim 4 including, while performing step (c), also directing gas from said output means of said booster compressor to said volume bottle, whereby compressed gas is conserved in said volume bottle.

6. Method of claim 4 including, when the pressure specification for said drilling fluid line increases following steps (c) and (d) to a value greater than 400 psi, (e) resuming the flow of gas to said drilling fluid line at least partly by directing gas from said volume bottle to said drilling fluid line.

7. Method of claim 4 wherein said gas is used as a component of said drilling fluid by injecting said gas into a liquid drilling fluid base.

8. Method of claim 7 wherein said gas is injected into said drilling fluid base in the form of microbubbles.

9. Method of claim 8 wherein said microbubbles are formed in said drilling fluid base by passing said gas through a membrane into said drilling fluid base.

10. Method of claim 8 wherein said microbubbles are formed in said drilling fluid base by a cavitation device.

11. Method of claim 4 wherein said gas is air.

12. Method of claim 4 wherein said gas comprises greater than 85% nitrogen.

13. Method of making a light weight drilling fluid comprising compressing a gas with at least one primary compressor, further compressing said gas with a booster compressor, passing said gas at least partly from said booster compressor into a microbubble machine, passing a base drilling fluid into said microbubble machine, thereby making a dispersion of microbubbles in said base drilling fluid, and withdrawing a light weight drilling fluid from said microbubble machine.

14. Method of claim 13 wherein said microbubble machine is a cavitation device.

15. Method of claim 13 wherein said microbubble machine comprises a membrane.

16. Readily transportable apparatus for conserving compressed gas at a well drilling site, said well drilling site having at least one primary gas compressor and a booster compressor, and a line for conveying drilling fluid to a wellbore, said readily transportable apparatus comprising:
at least one gas line including means for connecting said compressors to said drilling fluid line, and a volume bottle in said line for buffering pressure changes in said gas line.

17. Readily transportable apparatus of claim 16 wherein said well drilling site includes a source of drilling fluid comprising a liquid.

18. Readily transportable apparatus of claim 16 including a booster storage vessel for storing pressurized gas from said booster compressor and releasing said pressurized gas into said gas line.

19. Readily transportable apparatus of claim 16 including at least one microbubble machine for introducing microbubbles into a liquid drilling fluid.

20. Readily transportable apparatus of claim 16 wherein said compressed gas is air.
